(19) United States
(12) Patent Application Publication
(10) Pub. No.: US 2009/0109432 A1
(43) Pub. Date: Apr. 30, 2009

(54) Systems and methods for submersible imaging flow apparatus

(76) Inventors: Robert J. Olson, Cataumet, MA (US); Heidi M. Sosik, Falmouth, MA (US)

Correspondence Address: ROPES & GRAY LLP, PATENT DOCKETING 39/41, ONE INTERNATIONAL PLACE, BOSTON, MA, 02110-2624, US

(21) Appl. No.: 11/978,246

(22) Filed: Oct. 26, 2007

(51) Int. Cl. G01N 21/01

(52) U.S. Cl. 356/244

(57) ABSTRACT

The systems, methods, and apparatus described herein use a combination of video and flow cytometric technology to both capture images of organisms for identification and measure chlorophyll fluorescence associated with each image. Images can be automatically classified with software based on a support vector machine, while the measurements of chlorophyll fluorescence allow us to more efficiently analyze phytoplankton cells by triggering on chlorophyll-containing particles. Quantitation of chlorophyll fluorescence in large phytoplankton cells enables the interpretation of patterns in bulk chlorophyll data, and the discrimination of heterotrophic and phototrophic cells.

### BENEFIT CLAIM

This application claims the benefit of U.S. Provisional Application Ser. No. 60/854,286 filed Oct. 26, 2006, the contents of which are incorporated by reference.

### GOVERNMENT CONTRACTS

This research was supported by grants from NSF (Biocomplexity IDEA program and Ocean Technology and Interdisciplinary Coordination program; OCE-0119915 and OCE-0525700) and by funds from the Woods Hole Oceanographic Institution.

### TECHNICAL FIELD

The systems and methods described herein relate to submersible imaging flow apparatus that can monitor individual micrcoorganisms in the ocean by continuously recording the optical properties of individual suspended cells.

### BACKGROUND

Plankton in the size range 10-100 μm, which includes many diatoms and dinoflagellates, are critical components of coastal ecosystems, but their regulation is relatively poorly understood because it is difficult to sample them adequately in the dynamic coastal environment.

In the past, submersible flow cytometers were used to deploy fluorescence and light scattering signals from a laser beam to characterize the smallest phytoplankton cells (˜1-10 μm). Other commercially available instruments, such as the Autonomous Vertically Profiling Plankton Observatory are capable of monitoring plankton at the other end of the size spectrum (mainly zooplankton >100 μm). However, plankton in the size range 10-100 μm are not well sampled by either of these instruments. This is a critical gap because phytoplankton in this size range, which includes many diatoms and dinoflagellates, can be especially important in coastal blooms, while microzooplankton, such as protozoa, are critical to the diets of many grazers including copepods and larval fish.

Nano- and microplanktonic organisms can be studied in the laboratory or on board ships with a commercially available imaging flow cytometer, the FlowCAM. Other submersible flow cytometers have been developed, such as the CytoSub, but to our knowledge none has the necessary resolution and field endurance for the ecological studies we wish to carry out. There is a need for such an imaging flow device.

### SUMMARY

More specifically, the systems, methods, and apparatus described herein use a combination of video and flow cytometric technology to both capture images of organisms for identification and measure chlorophyll fluorescence associated with each image. Images can be automatically classified with software based on a support vector machine, while the measurements of chlorophyll fluorescence allow us to more efficiently analyze phytoplankton cells by triggering on chlorophyll-containing particles. Quantitation of chlorophyll fluorescence in large phytoplankton cells enables the interpretation of patterns in bulk chlorophyll data, and the discrimination of heterotrophic and phototrophic cells.

The systems, methods, and apparatus described herein address this sampling problem by autonomously obtaining quantitative data on nano- and microphytoplankton, with images of sufficient quality to allow taxonomic resolution to genus or even species level in some cases, high sampling resolution (˜hourly), and long endurance (months).

The systems, methods, and apparatus described herein are further enhanced by an automated image classification approach described in the paper by Applicants Sosik, H. M., and R. J. Olson, “Automated taxonomic classification of phytoplankton sampled with image-in-flow cytometry”, Limnology and Oceanography: Methods, 2006, hereby incorporated by reference in its entirety, will allow oceanographers to carry out a wide variety of studies of species succession, responses of communities to environmental changes, and bloom dynamics with vastly improved resolution and scope. Therefore, the systems, methods, and apparatus described herein will lead to improved understanding of many aspects of plankton ecology.

The systems and methods described herein include, among other things, an apparatus for imaging sea microorganisms. In one practice, a seawater sample is injected into the center of a sheath flow of particle-free water; all the particles are thus confined to the center of the flow cell, which ensures that each particle is in focus as it passes through the optical system. In another practice, the sheath fluid is recycled through a filter cartridge which removes sample particles after they have been analyzed. This allows for the efficient use of antifouling agents so the system can operate for months at a time without the need for maintenance or cleaning.

In an embodiment, the apparatus is contained in a watertight housing, and it operates continuously and autonomously under the direction of a computer whose programming can be modified by a remote operator.

In another embodiment, programmable operations include data acquisition and transfer to shore, adjustment of sampling frequency and rate of injection, injection of internal standard beads, flushing the flow cell and/or sample tubing with detergent, backflushing the sample tubing to remove potential clogs, adding sodium azide to the sheath reservoir to prevent biofouling of the internal surfaces, and focusing the imaging objective lens.

### BRIEF DESCRIPTION OF THE DRAWINGS

These and other features and advantages will be more fully understood by the following illustrative description with reference to the appended drawings, in which like elements are labeled with like reference designations and which may not be drawn to scale.

FIG. 1 shows an embodiment when it is removed from underwater housing. Three plastic standoffs prevent contact of the components and housing during installation. LEFT: front view, showing the “fluidics and optics” side of the optical breadboard. The flow cell (hidden by standoff) is located between the condenser and objective lenses. RIGHT: side view; the optical breadboard is edge-on in the center, with fluidics/optics components mounted to the left and electronics to the right;

FIG. 2 is a schema of fluidics system of an embodiment;

FIG. 3 is a schema of optical layout of an embodiment;

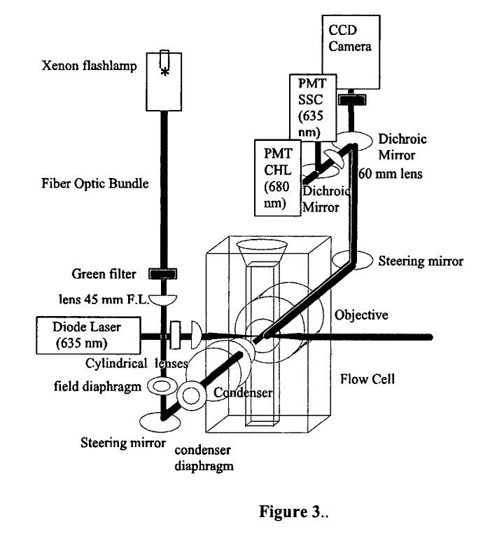

FIG. 4 depicts signals and controls typical of an embodiment

FIG. 5 shows a quantitation of cell counting obtained using the apparatus;

FIG. 6 depicts an analysis of uniform fluorescent beads which illustrates measurements of fluorescence and scattering;

FIG. 7 shows flow cytometric measurements of side scattering and chlorophyll fluorescence, and selected images of phytoplankton cells in a seawater sample from Woods Hole Harbor taken in December 2004, which were analyzed using the imaging apparatus (triggered by chlorophyll flourescence);

FIGS. 8 shows flow cytometric measurements of side scattering and chlorophyll fluorescence, and selected images of phytoplankton cells in a seawater sample from Woods Hole Harbor taken in December 2004, which were analyzed using the imaging apparatus (triggered by light scattering);

FIG. 9 shows microplankton community composition in a surface seawater sample from Woods Hole Harbor (9 Feb. 2006) which was analyzed by imaging apparatus and by microscopy;

FIG. 10 depicts phytoplankton cell concentrations measured by the apparatus during test deployment in Woods Hole Harbor in 2005.

### DETAILED DESCRIPTION OF ILLUSTRATIVE EMBODIMENTS

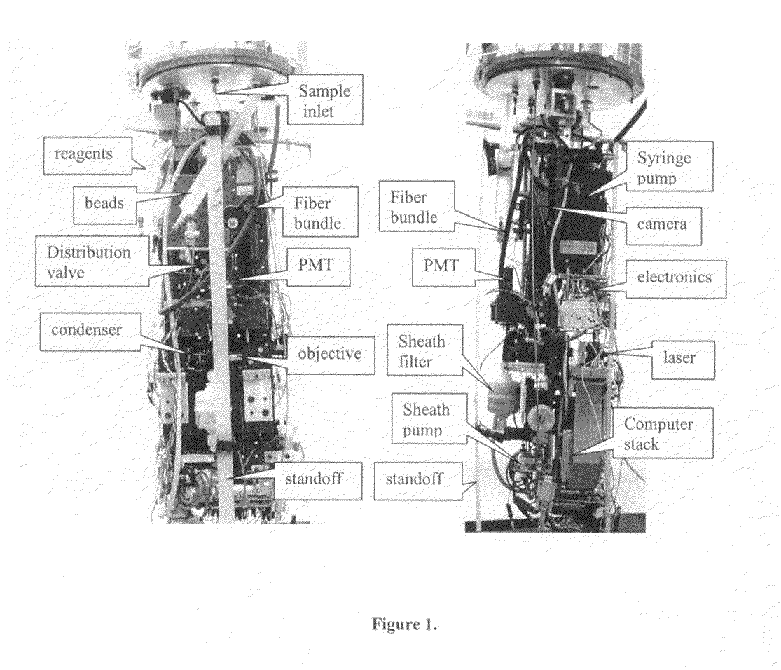

The invention, in various embodiments, provides systems and methods for imaging sea microorganisms. In an embodiment, the imaging apparatus is constructed around an optical breadboard (20.32×60.96 cm) with mostly off-the-shelf components; the fluid-handling and electronic components are mounted on opposite sides of the breadboard (FIG. 1). The breadboard hangs from the instrument end cap, which seals to the watertight housing (30.48 cm inner diameter×76.2 cm) via 2 nitrile o-rings and has external connections to an MVCO guest port for power and Ethernet communication with shore. Power is supplied as 36V DC (100 W). Communication (10 megabits sec⁻¹) between the instrument and the MVCO guest port are via Category-5 cable, and between the guest port and the shore laboratory via optic fiber (Austin et al. 2002).

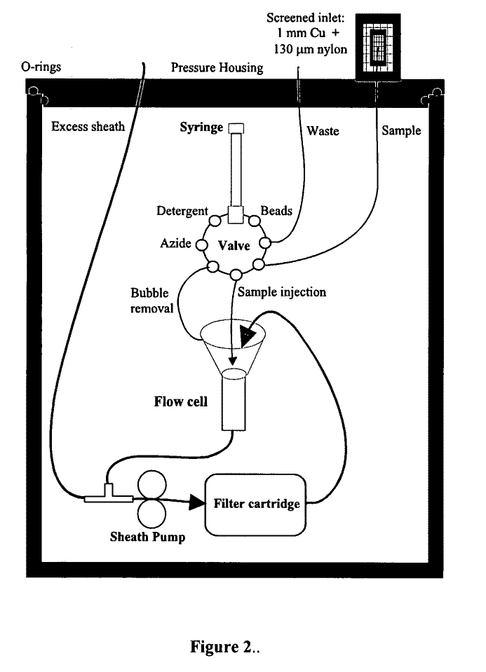

In an embodiment, the fluidics system (FIG. 2) of the apparatus is can be based on that of a conventional flow cytometer: hydrodynamic focusing of a seawater sample stream in a particle-free sheath flow carries cells in single file through a laser beam (and then through the camera's field of view).

The sheath fluid, seawater forced through a pair of 0.2 μm filter cartridges (Supor; Pall Corp.) by a gear pump (Micropump, Inc. Model 188 with PEEK gears), flows through a conical chamber to a quartz flow cell. The flow cell housing and sample injection tube is from a Becton Dickinson FACScan flow cytometer, but the flow cell is replaced by a custom cell with a wider channel (channel dimensions 800×180 μm; Hellma Cells, Inc.). Since the FACScan objective lens housing, which normally supports the plastic flow cell assembly, is not used here, an aluminum plate (3.175 mm thick) is bolted to the assembly.

Seawater is sampled through a 130 μm Nitex screen (to prevent flow cell clogging) which is protected against biolfouling by 1 mm copper mesh, and injected through a stainless steel tube (1.651 mm OD, 0.8382 mm internal diameter; Small Parts, Inc.) into the center of the sheath flow in the cone above the flow cell by a programmable syringe pump (Versapump 6 with 48,000 step resolution, using a 5-ml syringe with Special-K plunger; Kloehn, Inc.). The tubing is of PEEK material (3.175 mm internal diameter for sheath tubes, 1.588 mm for others; Upchurch Scientific).

An 8-port ceramic distribution valve (Kloehn, Inc.) allows the syringe pump to carry out several functions in addition to seawater sampling. These include regular (˜daily) addition of sodium azide to the sheath fluid (final concentration ˜0.01%) to prevent biofouling, and regular (˜daily) analyses of beads (20 μm or 9 μm red-fluorescing beads, Duke Scientific, Inc.) as internal standards to monitor instrument performance. In addition, the sample tubing (which is not protected from biofouling by contact with azide-containing sheath fluid) is treated with detergent (5% Contrad/1% Tergazyme mixture) during bead analyses (˜20 min d⁻¹) to remove fouling. Finally, the syringe pump is used to prevent accumulation of air bubbles (from degassing of seawater) in the flow cell, which could disrupt the laminar flow pattern; before each sample is injected, sheath fluid is withdrawn from the sample injection needle and from the conical region above the flow cell, and discarded to waste. Azide solution, suspended beads, and detergent mixture are stored in 100-ml plastic bags with Luer fittings (Stedim Biosystems).

In an embodiment, flow cytometric measurements are derived from a red diode laser (SPMT, 635 nm, 12 mW, Power Technologies, Inc.) focused to a horizontally elongated elliptical beam spot by cylindrical lenses (horizontal=80 mm focal length, located 100 mm from the flow cell; vertical=40 mm focal length, at 40 mm). Each cell passing through the laser beam scatters laser light, and chlorophyll-containing cells emit red (680 nm) fluorescence. One of these signals (usually chlorophyll fluorescence) is chosen to trigger a xenon flash lamp (Hamamatsu L4633) when the signal exceeds a preset threshold; the resulting 1-μs flashes of light are used to provide Kohler illumination of the flow cell. The green component of the light (isolated by a 530 nm bandpass filter) is focused into a randomized fiber optic bundle (50 μm fibers, 6.35 mm diameter; Stocker-Yale, Inc.). At the bundle exit, the light is collected by a lens, passes through a field iris, and is focused onto a condenser iris located approximately at the back focal plane of a 10× objective lens (Zeiss CP-Achromat, numerical aperture [N.A.] 0.25), which is in turn focused on the flow cell. A second 10× objective (Zeiss Epiplan, N.A. 0.2) collects the light from both flash lamp illumination (green) and laser (red, 635 nm scattered light and 680 nm chlorophyll fluorescence). Green and red wavelengths are separated by a dichroic mirror (630 nm short pass); green light continues to a monochrome CCD camera (UniqVision UP-1800DS-CL, 1380×1034 pixels), and red light is reflected to a second dichroic (635 LP), which directs scattered laser light and fluorescence to separate photomultiplier (PMT) modules (Hamamatsu HC120-05 modified for current-to-voltage conversion with time constant=800 kHz; the PMT for laser scattering also incorporates DC restoration circuitry).

In an embodiment, the optical path is folded by broadband dielectric mirrors (Thorlabs BB1-E02) on either side of the flow cell to conserve space. The flow cell assembly is fixed to the optical table, while the light source/condenser and objective/PMT/camera assemblies are each mounted on lockable translators (Newport Corp.) providing 3 degrees of freedom for adjustment. The objective focusing translator is remotely controllable (see Instrument Control below). Optical mounting hardware is from Thorlabs, Inc.

In an embodiment, the imaging apparatus is controlled by a PC-104plus computer (Kontron MOPS-LCD7, 700 MHz) running Windows XP (Microsoft Corporation). Remote operation is carried out via Virtual Networking Computing software (www.realvnc.com). The camera is configured and the syringe pump is programmed by software provided by the manufacturers; all other functions (control, image visualization, and data acquisition) are carried out by custom software written in Visual Basic 6 (Microsoft Corporation).

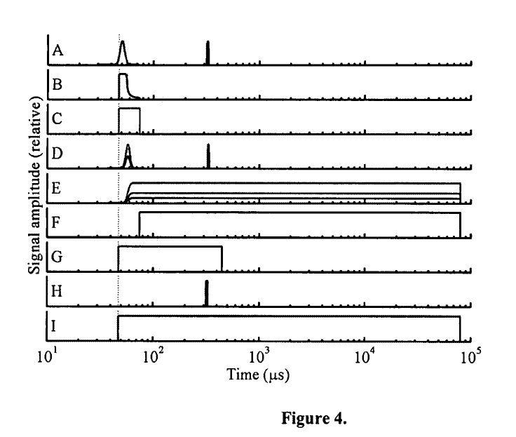

In one practice, a custom electronics board amplifies and integrates light scattering and fluorescence signals, and also generates control pulses for timing purposes (FIG. 4). The signal from the triggering PMT (typically chlorophyll fluorescence) is split, with one part sent to a comparator circuit that produces a trigger pulse if the signal is larger than a preset threshold level. The other part of the signal, and the signal from the other PMT, are delayed by 7 μs (by delay modules from a Coulter Electronics EPICS 750 flow cytometer) and then split and sent to paired linear amplifiers with 25-fold different gains (to increase dynamic range) before integration (Burr-Brown AFC2101). The delay modules allow the pre-trigger portions of the signals to be included in the integration. The end of the integration window is also determined by the comparator, with the provision that the signal remains below the comparator threshold for 20 μs; this allows signals from loosely-connected cells such as chain diatoms to be more accurately measured. Comparator output pulses are also integrated to provide an estimate of the duration of each signal. The PMT amplifier inputs are grounded by transistors during flash lamp operation to avoid baseline distortion by the very large signals from the flashes (FIG. 4A, D).

In a practice, the trigger pulse is also sent to a frame grabber board (Matrox Meteor II CL) to begin image acquisition, and, after a delay of 270 μs, to the flash lamp, which illuminates the flow cell for a 1 μs exposure. Integration of light scattering and fluorescence signals is limited to 270 μs to avoid contamination by light from the flash lamp, so integrated signals from cells or chains longer than ˜600 μm are conservative estimates.

In an embodiment, a multifunction analog-digital (A-D) board (104-AIO16-16E, Acces I/O Products, Inc.) digitizes the integrated laser-derived signals and the duration of the triggering signals, produces analog signals to control the PMT high voltages, and carries out digital I/O tasks (e.g., motor control for focusing the objective and communication between software and hardware, i.e., inhibiting new trigger signals while the current image is being processed).

In an alternative embodiment, to minimize the resources needed for image data storage, the apparatus utilizes a “blob analysis” routine (Matrox Imaging Library 7.5) based on edge detection (changes in intensity across the frame) to identify regions of interest in each image. The subsampled images are transferred to a remote computer for storage and further analysis. For taxonomic classification, we developed an approach based on a support vector machine framework and several different feature extraction techniques; this approach is described elsewhere (Sosik and Olson 2006), along with results of automated classification of 1.5×10⁶ images obtained during the apparatus's test deployment in Woods Hole Harbor.

For each particle, 5 channels of flow cytometric signal data are stored (integrated signals from fluorescence and light scattering detectors at 2 gain settings each, plus signal duration), along with a time stamp (10-ms resolution). Accumulated images and fluorescence/light scattering data are automatically transferred to the laboratory in Woods Hole every 30 min. The data are analyzed using software written in MATLAB (The Mathworks, Inc.).

In practice, the apparatus can be deployed by divers, who bolt the neutrally buoyant 70-kg instrument to a mounting frame located at 4-m depth on the MVCO Air Sea Interaction Tower (http://www.whoi.edu/science/AOPE/dept/CBLAST/ASIT.html), and connect the power and communications cable, which is equipped with an underwater pluggable connector (Impulse Enterprise, Inc.). An embodiment of the apparatus has been deployed at MVCO since 27 Sep. 2006.

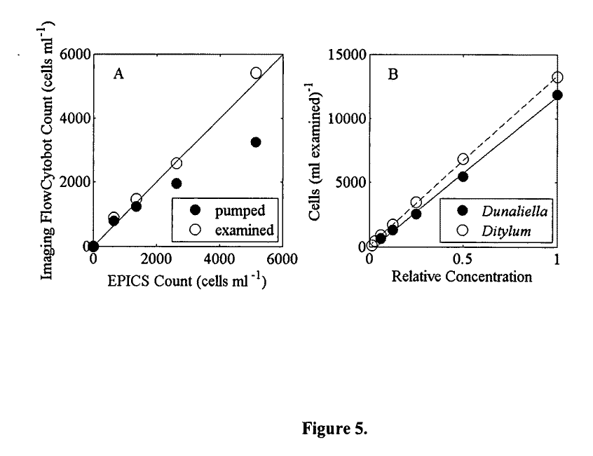

FIG. 5 shows cell quantitation achieved by hydrodynamic focusing that causes all the cells in a sample to pass through the apparatus's analysis region, so cell concentrations can be calculated, to a first approximation, by dividing the number of triggers by the volume of water analyzed (as determined by the analysis time and the known rate of flow from the syringe pump). However, this concentration is an underestimate, because during the time required to acquire and process each image, sample continues to flow through the flow cell but no new triggers are allowed. The minimum time required by the camera for image acquisition is 34 ms (i.e., 30 frames s⁻¹), but we determined empirically that with image processing to locate and store the region of interest, at least 86 ms was required by the system; very large cells required even more time. We therefore measure the image processing period for each cell using a software timer. By subtracting the sum of these periods from the total elapsed time, we determine how much time is actually spent “looking” for cells, and use this value to calculate cell concentration in each syringe sample.

To evaluate cell quantitation by the apparatus, replicate samples can be analyzed with both the apparatus and a Coulter EPICS flow cytometer, a non-imaging instrument capable of measuring cells at rates >10³ sec⁻¹. We used a laboratory culture of Dunaliella tertiolecta, a small (6 μm) phytoplankter, because cells in this size range can be reliably analyzed by both instruments. Using the measured analysis time as described above, The apparatus-derived cell concentrations are indistinguishable from those of the EPICS flow cytometer (FIG. 5A).

Analyses of dilution series of Dunaliella and of a much larger diatom (Ditylum brightwellii, ˜20×100 μm), which often required additional time (>86 ms) for image processing, indicated that cell concentrations from The apparatus were reliable for both sizes of cells, up to at least 1.5×10⁴ cell ml⁻¹ (FIG. 5B), very high concentrations for marine nanoplankton.

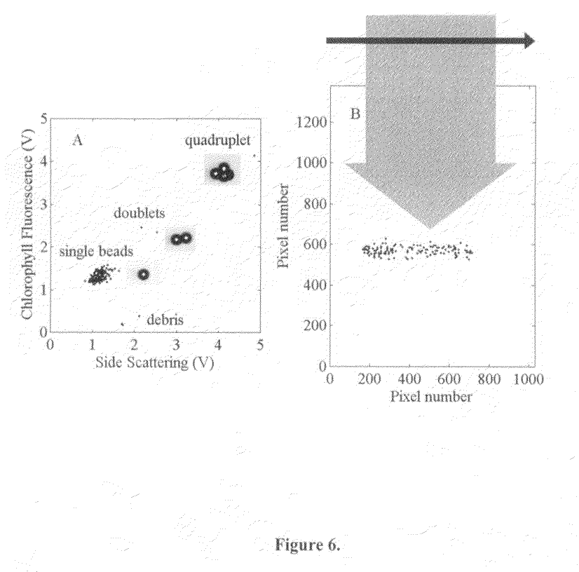

FIG. 6 shows measurements of uniform beads that indicate that light scattering and fluorescence data are quantitative; signals are uniform across the 150 μm-wide sample core, and the coefficient of variation of bead fluorescence signals is typically <10% even after extended periods of deployment. Although the flow cytometric measurements are probably of less interest than the images of cells, it is important to note that the acquisition of each image is initiated by the detection of a signal exceeding a threshold, so it is important to monitor detection efficiency during operation.

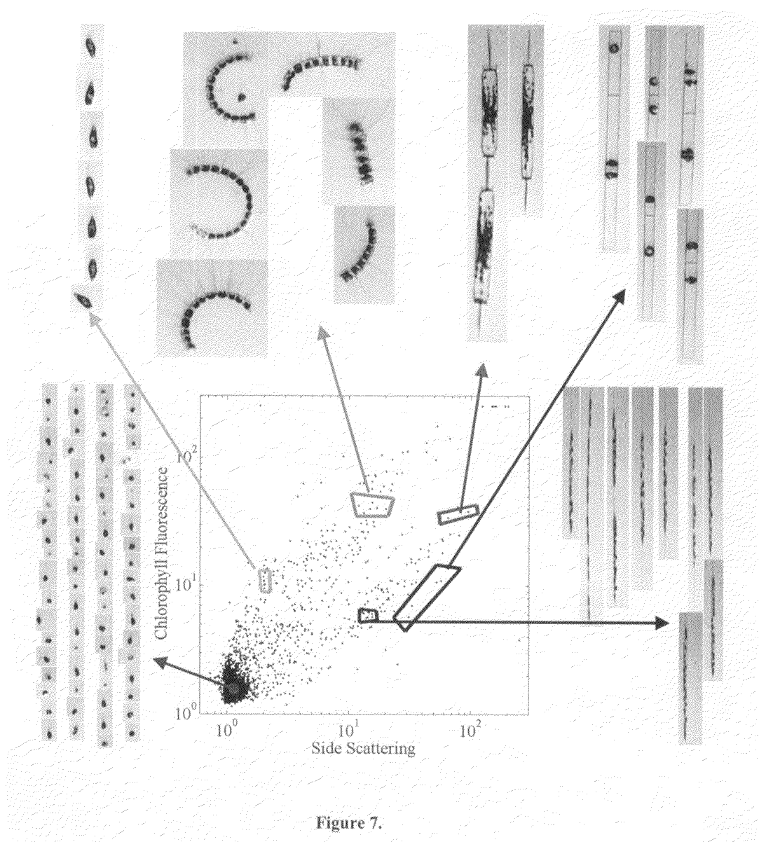

Analysis of seawater samples by the apparatus illustrates some advantages of the approach over conventional flow cytometry and manual microscopic analyses. Firstly, flow cytometric sorting of particles in seawater have shown that light scattering/fluorescence signatures are rarely sufficient to identify nano- or microplankton at the genus or species level. Discrete populations are rarely discernible in a plot of light scattering vs fluorescence (e.g., see FIG. 7), and even if they are, it is difficult to be sure of their identity without cell sorting and examination. The images associated with the flow cytometric data reinforce this idea—different species do have characteristic light scattering/fluorescence signatures, but these generally form a continuum (and often overlap) and so are not very useful in determining species composition. (The homogenous populations of cells indicated by the image groupings in FIG. 7 are not random selections, but were obtained by trial-and-error searches of small regions of the plot; other regions show mixtures of species). Thus, imaging allows us to greatly improve the accuracy of identification of different cells.

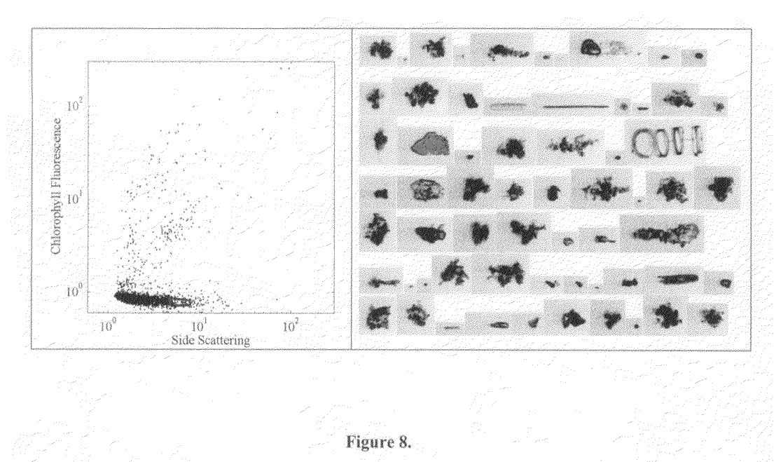

FIG. 8 shows that imaging can also be used to study non-phytoplankton particles, whose composition and abundance patterns are almost unknown. Triggering from light scattering rather than fluorescence signals reveals that the large majority of the particles in this seawater sample were not phytoplankton, but included various forms of detritus, empty diatom frustules, and heterotrophic organisms.

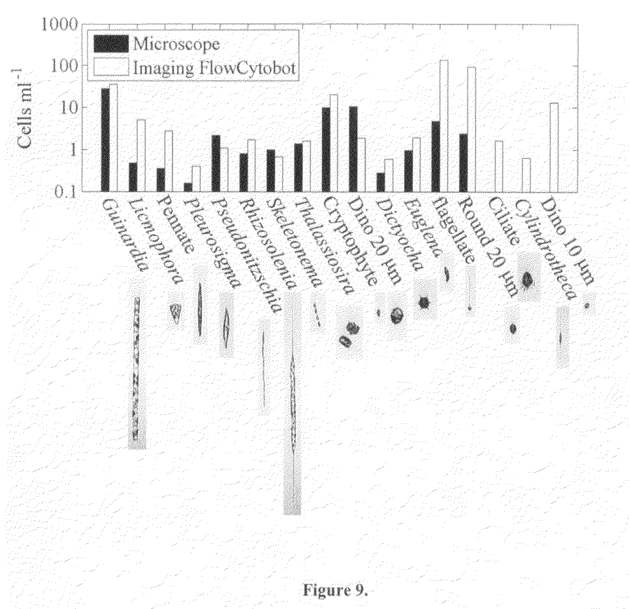

Preliminary comparisons of the apparatus's performance to traditional manual microscopy are encouraging are shown in FIG. 9. For the dominant and most easily recognized cells in the water sample (the diatom Guinardia spp.), the counts were very close. For some categories, such as dinoflagellates, The apparatus counts were lower, probably because the distinguishing features of dinoflagellate cells (e.g., cingulum) were not always visible in the images (due to orientation) or were insufficiently resolved. Dinoflagellates are often highly pigmented relative to other cells of interest, so the illumination conditions used in The apparatus caused the cells to appear very dark (even though green illumination, which is not strongly absorbed by photosynthetic pigments, was used to minimize this effect). It is likely that many dinoflagellates were classified as “Round 20 μm cells”, of which The apparatus saw many more than the microscopist. For almost all of the more rare categories, The apparatus found more cells than microscopy, sometimes many more. Sometimes this was because the plankton groups were not counted by the kind of microscopy/sample preservation method used (ciliates, small dinoflagellates, flagellates), but others remain unexplained (Cylindrotheca, Licmophora, pennate diatoms).

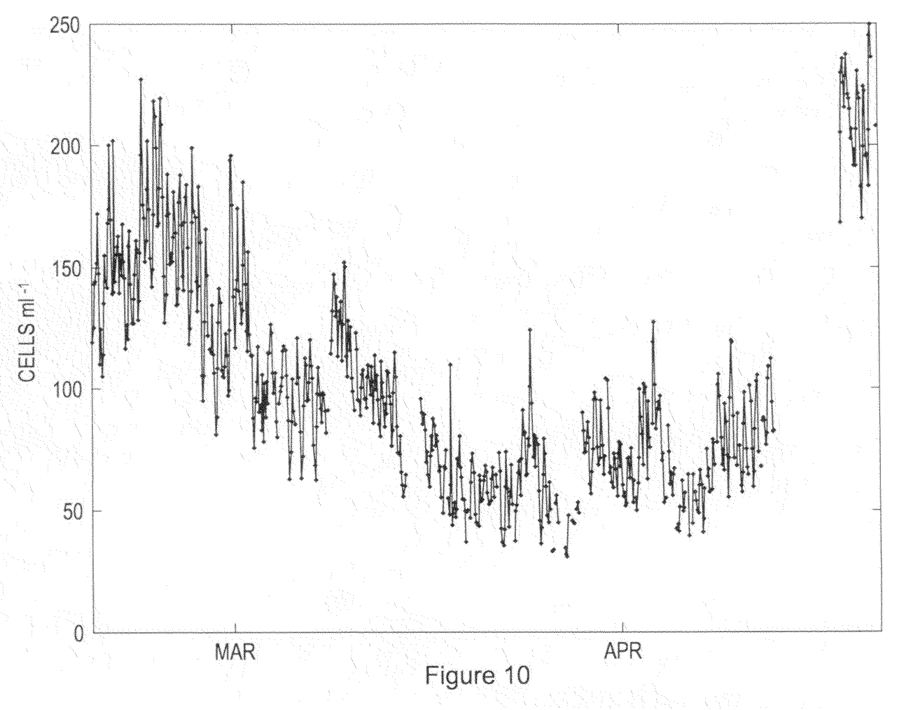

Another benefit of the apparatus is the greatly increased scope made possible by the automated nature of the approach. A test deployment of The apparatus at 5 m depth off the WHOI pier as shown in FIG. 10 is that the instrument is capable of operating without external maintenance for at least 2 months. The results presented here are simply cell counts, showing long term trends in cell abundance, with superimposed higher-frequency periodicity (probably tidal). Analyzing seawater at a nominal rate of 0.25 ml min⁻¹, over 1.5 million images were collected during this deployment; the analysis of these images with an automated approach is presented in Sosik and Olson, 2006.

The ultimate resolution of the optical system is determined by the 10× microscope objective, which has a theoretical resolution of ˜1 μm. As presently configured, a 20 μm bead spans 68 pixels (3.4 pixels/μm), so the camera resolution is more than adequate for this objective. However, image quality will be affected by several additional factors in The apparatus, including cell motion, flash lamp pulse duration, and location of cells in the flow cell.

Movement of the subject due to sheath flow during the camera exposure will tend to blur the image in the direction of flow. Sample particle velocity was determined (by measuring the image displacement caused by a known change in strobe delay) to be 2.2 m s⁻¹, so the subject moves 7.5 pixels during the 1 μs exposure. The effect of this movement is visible in an image of a plastic bead as a thickening of the leading and trailing edges, relative to the upper and lower edges (not shown). In addition, although most of the light energy from the xenon flash is emitted within 1 μs, the flash decays over several Us, which produces a “shadow” downstream of high-contrast subjects. These factors limit the velocity of flow that can be employed, and thus the sampling rate of the instrument (although a shorter flash, as from an LED or pulsed laser, could be used to address this limitation).

The sample core in the apparatus is about 150 μm wide (see FIG. 6B), so if we assume that the core has the same shape as the channel, the thickness of the core would be ˜33 μm. This is somewhat greater than the theoretical depth of focus of a 10× objective with N.A. 0.2 (˜10 μm). As the thickness of the sample core increases, more particles will be out of focus, which will limit both the sampling rate and the optical resolution that can be employed. Finally, the illumination conditions (e.g., condenser aperture, which is dictated by the amount of light available during the flash) affect the resolution and contrast of the image.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for imaging organisms in the ocean comprising:
Collecting a sample of seawater within a sheath flow of substantially particle-free water;
Confining the particles to a center of the flow cell, and
passing the flow through an optical system.
